(19) United States
(12) Patent Application Publication
(10) Pub. No.: US 2008/0208610 A1
(43) Pub. Date: Aug. 28, 2008

(54) Methods and Systems for Script Operations Management

(76) Inventors: Nicholas Arthur Thomas, Orem, UT (US); Tyler Kevin Park, Sandy, UT (US)

Correspondence Address: KIRTON & McCONKIE;A PROFESSIONAL CORPORATION, ATTORNEYS AT LAW, 1800 EAGLE GATE TOWER, 60 EAST SOUTH TEMPLE STREET, SALT LAKE CITY, UT, 84111, US

(21) Appl. No.: 12/039,481

(22) Filed: Feb. 28, 2008

Related U.S. Application Data
(60) Provisional application No. 60/892,229, filed on Feb. 28, 2007.

(51) Int. Cl. G06Q 10/00

(52) U.S. Cl. 705/1

(57) ABSTRACT

Systems and methods for detecting, reporting and repairing of damaged scripts used to obtain financial account information from financial institutions are described, along with systems and methods for improved communications to users of financial software of the status of repair efforts. The systems and methods provide for improved speed in repairing script errors. In some embodiments, the script errors may be detected and repaired before a user even notices and/or reports the script error. In addition, the systems and methods provide for automatic detection and prioritization of script errors in conjunction with enhanced response times to script errors reported by users of financial software. Benefits are provided to the user experience, as well as to the efficiency of and resources required of service providers to repair broken scripts.

### CROSS-REFERENCE TO RELATED APPLICATIONS

This application claims the benefit of U.S. Provisional Application No. 60/892,229, filed Feb. 28, 2007.

### BACKGROUND OF THE INVENTION

1. Field of the Invention

The present invention relates to management of script operations, and more particularly to management of repairs of broken scripts used by financial account aggregators to access multiple on-line financial accounts.

2. Background and Related Art

Many financial programs may be used to keep track of finances. For example, individuals or businesses often use financial tracking software to keep budgets, monitor account balances (often for multiple accounts), and initiate certain financial transactions such as bill payments. Ideally, such financial tracking software is able to access a user's accounts directly, typically through an online process, and therefore has access to up-to-date information on the user's various financial accounts.

Many users, both individual users and business users, may have multiple financial accounts with different institutions. In addition, the makers of the financial tracking software desire to make their software usable by many, most, or even all potential users. Therefore, the makers of such software must include in the software the capability to access a great number of financial accounts. This desire may be hindered by the great variety in login requirements used by the different financial institutions. For example, to access accounts at one institution, a user may simply need to access that institution's webpage and enter a username and password in appropriate fields. At another institution, however, the user may have to enter a username and password and then answer a challenge question selected from a finite set of challenge questions previously selected by the user. At still other financial institutions, other processes may be required, and Internet browser “cookies” may be required in some instances or may modify the login requirements when present on a particular computer used by the user.

To allow the financial software to successfully login to the various financial institutions and accounts for various users, the software maker or support provider typically uses scripts. Scripts are automatic sets of commands that automate logging in to a particular financial institution's financial account information on behalf of a user (or any number of users) to access account information. When a proper functioning script is in place, the user of the financial tracking software may enter the appropriate login information (including any answers to challenge questions, for example) to the financial tracking software, and the software uses the information to access the user's account information.

While users can typically initiate account updates manually by requesting that the financial software login to the user's accounts and update the account information, in many instances it is advantageous to provide for automatic updating of the user's accounts, such as daily. In many instances, this may be done at night or at another time when the user is not busy using the financial software. With the increase in Internet usage and improved connectivity, many financial software providers now act as aggregators, automatically accessing multiple users' accounts and storing the update information in central servers. Then, when the various users turn on their computers, connect to the Internet, and access their financial software, the financial software automatically checks with the aggregators' servers to determine if any account updates are available. Any available updates may be automatically downloaded, greatly reducing the amount of time necessary for any updating to occur. Many users of financial tracking software find such updates to be timesaving and desirable.

However, serious problems exist. In many instances, financial institutions change their websites, change their account access procedures (such as requiring an answer to a challenge question where none was required before), or otherwise change some facet of the online account access procedure in such a way that the automatic scripts used by the financial tracking software and aggregators fails to successfully access users' accounts. In some cases, certain financial institutions may make changes that prevent the scripts from functioning on a fairly regular basis. This is extremely problematic for financial software providers, as it disrupts access by the aggregators and prevents the users from successfully updating their account information. Typically, the users do not realize that the failure to update is due to changes made by their financial institutions, but instead erroneously believe that the problem lies in the financial tracking software or with the service provider providing the financial tracking software. This is obviously bad for the customer image of the software service provider, and financial software service providers must dedicate significant resources to repairing defective scripts used to fetch user account information.

Unfortunately, current methods of repairing broken scripts are inefficient and do little to reduce the workload for aggregators and the service providers. Currently, when an attempt to update a user's account is made (whether a manual attempt initiated by a user or an automatic attempt made by an aggregator for one or many accounts) that fails due to a script error, an error code is generated and any and all users who open the financial tracking software and/or attempt to update their account information are given a prompt to call support and report the applicable error code. Support then works to fix the script error (often using a third-party provider) and, when the script error is fixed, e-mails the user who reported the script error that the error has been fixed. While this method works fairly well when only a small number of users are affected by a script error, this method becomes increasingly cumbersome as larger numbers of users are affected.

In particular, as all such users are provided the error code and prompt to call support, a large number of calls to support may be generated. The customer support staff must then expend a great amount of time and other resources fielding customer calls about the script error (many simply repeating the same error with the same provider), properly logging the calls, and generating responses (by e-mail or telephone) to the consumers when the problem has been fixed.

There are other problems encountered as the service provider customer support staff fixes broken scripts. In many instances, multiple scripts for multiple financial institutions may be broken simultaneously. Aggregators and other service providers, however, may not have any mechanism to guide them in understanding the number of users affected by broken scripts and may have very little guidance in choosing how to prioritize the order in which to fix broken scripts. In addition, scripts may be broken in multiple layers affecting different users differently. Therefore, an aggregator may fix a particular script and may believe that the problem is fixed for all users who have received an error code for a particular institution. Because of the limited resources of the aggregators and support staff, it is generally difficult to test broken scripts for all users reporting the problem. Instead, the aggregators perform some minimal testing for several users and then are forced to notify all users that the service provider believes the error to be fixed. Only when some users report additional errors are additional layers of script errors discovered. Of course, notifying users of corrections only to force those users to discover additional errors is disadvantageous for the image of the financial tracking software provider and aggregator.

Additionally, the service provider traditionally has no way to notify users of progress being taken to repair script errors. As discussed above, this may result in a large volume of error-reporting calls as multiple users report the same error. In addition, however, when some scripts take time to repair, anxious or impatient users may make multiple calls to customer support checking on the status of script repairs, putting additional burdens on support staff. In other instances, communication of progress in script repair may be further hindered by the fact that many aggregators use third parties to perform some script repair services, adding an additional communication layer that hampers reporting of repairs and repair progress to the financial tracking software consumers.

Each of the above-discussed problems may be further complicated in instances where a particular financial institution adds an additional layer of protection on account access, such as adding a challenge question to account access. In such instances, merely fixing a script is insufficient to allow the aggregator and/or financial software to retrieve a user's account. Instead, additional information must be received from the account holder to permit such access. Therefore, when the script is repaired, the customer service representatives must contact account users and request that the users provide the additional information. This further burdens the already-stretched resources of the customer support provider/aggregator.

### BRIEF SUMMARY OF THE INVENTION

Embodiments of the present invention provide for improved responses by aggregators and other service providers in connection with financial services software. The embodiments of the invention also provide improved methods of detecting script errors, reporting script errors to customer service providers, and tracking the progress of script error repairs. Additionally, improved reporting of the progress of script repairs to users of financial services software is provided by embodiments of the present invention. Embodiments of the invention therefore provide benefits to users of financial services software as well as to aggregators, providers of the financial software, and other service providers involved in providing account updates to users of financial services software.

The embodiments of the invention provide for improved speed in repairing script errors. In some embodiments, the script errors may be detected and repaired before a user even notices and/or reports the script error. In addition, embodiments of the invention provide for automatic detection and prioritization of script errors in conjunction with enhanced response times to script errors reported by users of financial software. Benefits are provided to the user experience, as well as to the efficiency of and resources required of service providers to repair broken scripts.

Users benefit in that they are provided with improved methods for reporting broken scripts to the service providers/aggregators. Reporting may be simplified and may only require a single click or action from within the financial software rather than requiring a telephone call to customer service. In addition, customers benefit in that all customers affected by a single script error may be notified of repair efforts immediately upon one customer's request, and thus most users need not independently report a broken script and may optionally elect to receive notices of script repair. Users are also provided improved communication and updates of the service provider's efforts in repairing broken scripts, with much of the improved communication being delivered directly to and through the financial software. The embodiments of the invention therefore improve the overall user experience in many ways.

Service providers may benefit by limiting customer service contacts to as few as one contact, and that single contact, in many instances, may be limited to an automated contact rather than a person-to-person contact. This may greatly reduce the resources a service provider must dedicate to customer-contact-type customer service, and such resources may be reapplied to improving the turnaround time for script repair. This may provide ancillary benefits of improving the thoroughness of repairs so as to allow testing of all accounts affected by broken scripts as well as other benefits. Service providers and customers alike are benefited by improved communication between customers, service providers, and third parties, and all parties may be better aware of repair efforts and progress. Service providers may be further benefited through improved proactive and reactive queuing of service requests and other repairs, including those script repair needs that may be automatically detected by the service provider.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a configuration of a representative computer device that may be used in accordance with embodiments of the present invention;

FIG. 2 shows a representative networked computer system suitable for use with embodiments of the invention;

FIG. 3 shows a representative of a networked computer configuration suitable for use with embodiments of the invention;

FIG. 4 illustrates a representative screen view presented to a user of an illustrative embodiment of the invention;

FIG. 5 illustrates a representative screen view presented to a user of an illustrative embodiment of the invention;

FIG. 6 illustrates a representative screen view presented to a user of an illustrative embodiment of the invention;

FIG. 7 illustrates a representative screen view presented to a user of an illustrative embodiment of the invention;

FIG. 8 illustrates a representative screen view presented to a user of an illustrative embodiment of the invention;

FIG. 9 illustrates a representative screen view presented to a user of an illustrative embodiment of the invention;

FIG. 10 illustrates a representative screen view presented to a service provider in an illustrative embodiment of the invention; and

FIG. 11 illustrates a representative screen view presented to a service provider in an illustrative embodiment of the invention.

### DETAILED DESCRIPTION OF THE INVENTION

A description of the embodiments of the present invention will be given with reference to the appended Figures. It is expected that the present invention may take many other forms and shapes, hence the following disclosure is intended to be illustrative and not limiting, and the scope of the invention should be determined by reference to the appended claims.

Embodiments of the present invention provide for improved responses by aggregators and other service providers in connection with financial services software. The embodiments of the invention also provide improved methods of detecting script errors, reporting script errors to customer service providers, and tracking the progress of script error repairs. Additionally, improved reporting of the progress of script repairs to users of financial services software is provided by embodiments of the present invention. Embodiments of the invention therefore provide benefits to users of financial services software as well as to aggregators, providers of the financial software, and other service providers involved in providing account updates to users of financial services software.

The embodiments of the invention provide for improved speed in repairing script errors. In some embodiments, the script errors may be detected and repaired before a user even notices and/or reports the script error. In addition, embodiments of the invention provide for automatic detection and prioritization of script errors in conjunction with enhanced response times to script errors reported by users of financial software. Benefits are provided to the user experience, as well as to the efficiency of and resources required of service providers to repair broken scripts.

In the description and in the claims, the term “ticket” is used to refer to a record utilized by a service provider to track a script error from at least the time the script error is first detected/reported until the time the script error is corrected/repaired. A ticket may include one or multiple paper and electronic record(s), and may sequentially and/or simultaneously exist in more than one location/database. A ticket may also include information as to the progress of error repair, account(s) affected, time of detection/reporting of the error, etc.

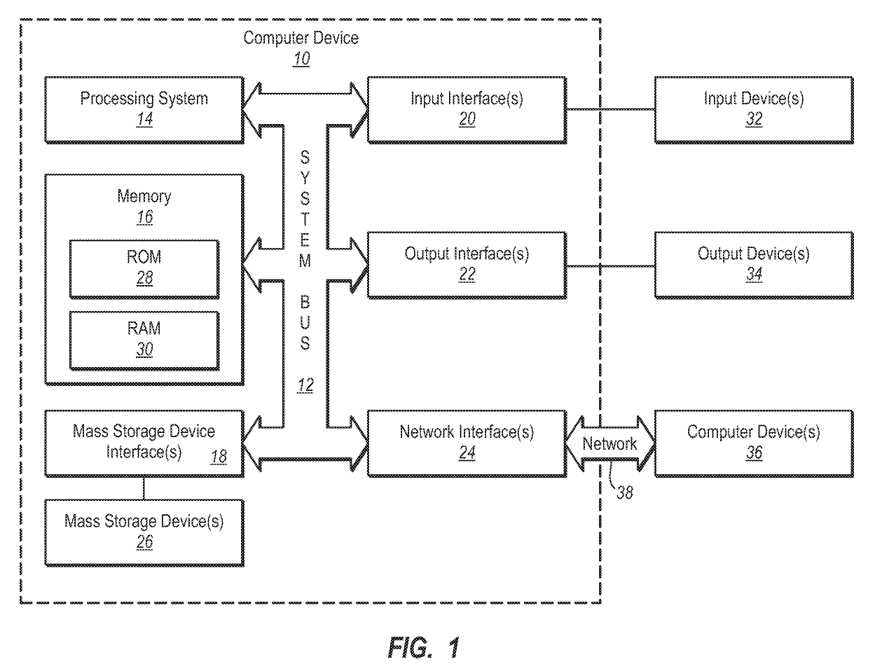

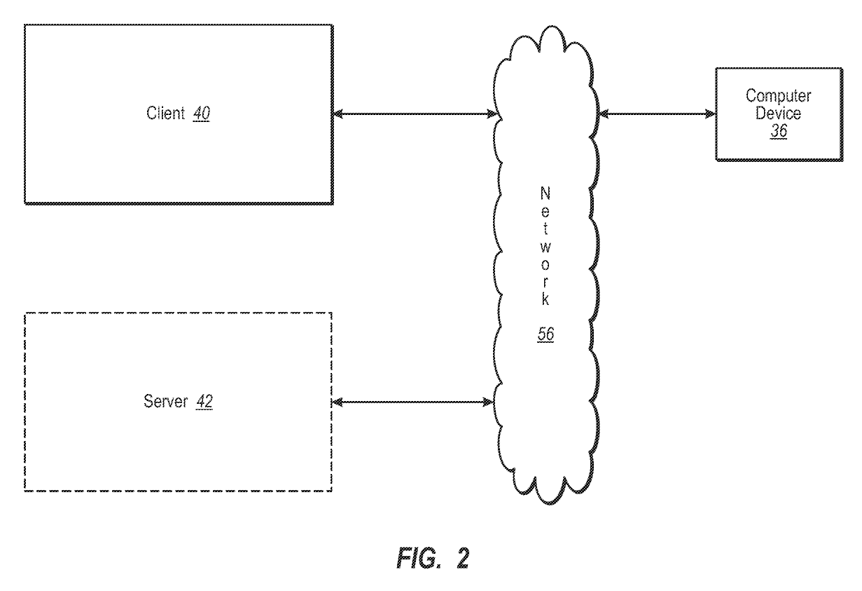

Inasmuch as at least some embodiments of the present invention embrace utilization of a computer device, FIGS. 1 and 2 and the corresponding discussion are intended to provide a general description of some suitable operating environments in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), non-volatile random-access memory (“NVRAM”), read-only memory (“ROM”), programmable read-only memory (“PROM”), erasable programmable read-only memory (“EPROM”), electrically erasable programmable read-only memory (“EEPROM”), flash memory (e.g., a USB thumb-drive, a memory card, etc.), compact disk read-only memory (“CD-ROM”), magnetic memory (e.g., a hard drive), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”), cellular camera phone, digital camera or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, a flash memory device, or from a communication connection, which may also be viewed as a computer readable medium.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives, flash memory devices, and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

Memory 16 may include one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, a bioreader sensor, and the like. Similarly, examples of input interfaces 20 that may be used to connect the input devices 32 to the system bus 12 include a serial port, a parallel port, a game port, a universal serial bus (“USB”), IEEE 1394, IrDA, Bluetooth, Wi-Fi, Wi-MAX or another interface.

One or more output interfaces 22 may be employed to connect one or more corresponding output devices 34 to system bus 12. Examples of output devices 34 include a monitor or display screen, a printer, a plotter, a multi-function device, or other output device. A particular output device 34 may be integrated with or peripheral to computer device 10. Examples of output interfaces 22 include a video adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces 24 include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

While those skilled in the art will appreciate that embodiments of the present invention may be practiced in a variety of different environments with many types of computer system configurations, FIG. 2 represents a representative networked system configuration that may be used in association with an embodiment of the present invention. While FIG. 2 illustrates an embodiment that includes a client computer 40, another computer device 36, and a server 42 connected to a network 38, alternative embodiments include more than one client computer 40, no server 42, and/or more than one server 42 connected to the network 38. Moreover, embodiments in accordance with the present invention also include wireless networked environments, or where the network 38 is a wide area network, such as the Internet. In most embodiments, the client 40 is at least intermittently connected to a wide area network 38, such as the Internet, or intermittently directly connected to another computer device so connected to facilitate retrieval of recent account information for use by the financial services software.

As will be readily appreciated by those of skill in the art, financial services software for use in conjunction with the embodiments of the present invention may include any type of financial software, including personal financial software and business financial software of any level of complexity. As will also be readily appreciated, the financial software may be partially or fully located on a local client computer 40 or may be partially or completely distributed between multiple computers. Alternatively, the software may be remotely located on a service provider's computer such as a remote server 42 to be accessed over the network 38 (such as over the Internet through a web page) by a user using a client computer 40. This permits a user to access the user's financial software from nearly any worldwide location and to have access to the user's financial account information on an updated basis through the remotely-located software. In some instances, layers of servers 42 provided by a service provider may provide different aspects of the functionality of the software described herein, and some functionality may be provided by third parties on computer systems controlled by those third parties and connected to the service provider's computers/servers by network links similar to network 38. Thus, one of skill in the art will readily recognize the wide range of computer systems and configurations that may be used in conjunction with embodiments of the present invention.

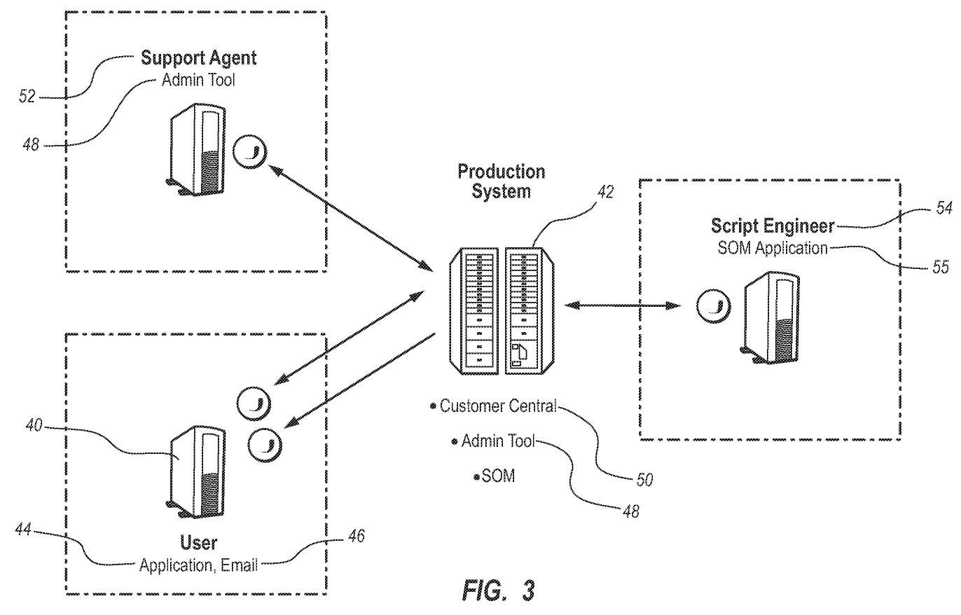

FIG. 3 displays one distributed system and network environment that may be used in accordance with embodiments of the present invention. In the illustrated embodiment, a user may access a financial software application 44 on the user's computer (or accessed via a webpage as discussed above), illustrated as a client computer 40. The user may also be able to receive e-mail 46 communications, either as a part of the financial software application 44 or as a separate software program. The user's computer may be connected, at least intermittently, with a server 42 that is part of a production system controlled by and used by the financial software service provider. The server 42 and production system may make up a portion of a script operations management or script operations managing (“SOM”) system, and may include an administrative tool or application 48 and may include a central customer service application 50. The SOM system may further include other local or remote networked computers as illustrated in FIG. 3, including one or more computers used by support agents 52 who access the SOM system and provide customer support, and one or more computers used by script engineers 54 who access the SOM system and work on outstanding script errors that have been discovered or reported. The computers used by the script engineers 54 may have a SOM application 55 on them to permit the script engineers 54 to work to correct script errors and to report on progress made in correcting the broken scripts.

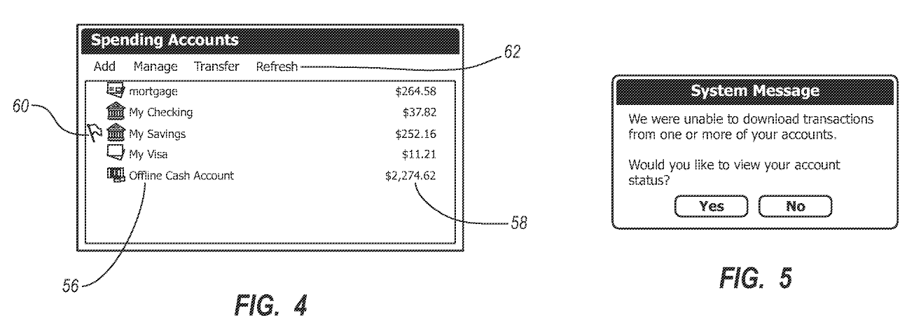

The user, upon opening or logging on to the financial software application 44, or at some point when using the financial software application 44, may be presented with a summary display screen such as that depicted in FIG. 4. In the summary screen of FIG. 4, the user is able to see a listing of various accounts 56 as well as account balances 58. The account balances 58 may be actual updated account balances reflecting actual funds in the various accounts 56, or they may be account balances solely as maintained within the user's computer or within the financial software application 44 and may reflect charges or credits to the accounts 56 that may not have cleared at the user's financial institutions. Also shown in FIG. 4 is an account status flag 60. Status flags 60 may be of various colors and/or shapes to signal to the user various different statuses for the user's accounts 56. The summary screen may also be provided with a refresh button 62 that, when selected by the user, initiates a manual update through the network 38 of the status of the user's accounts 56.

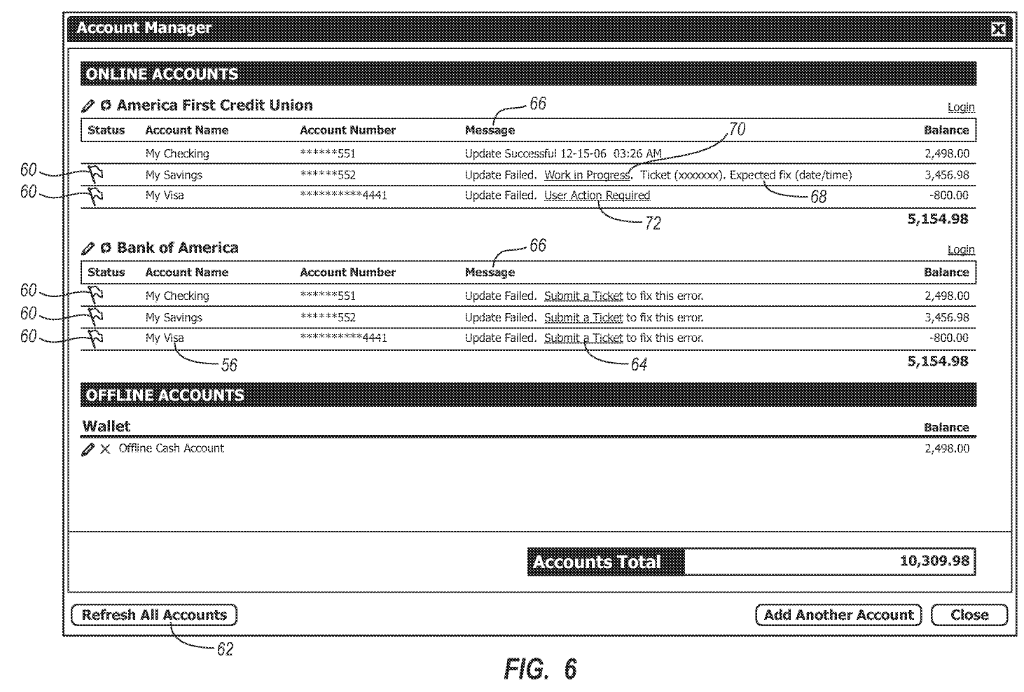

In many instances, selecting the refresh button 62 will seamlessly provide an update of the user's accounts 56. However, if the scripts used to access one or more of the user's financial institutions holding the actual accounts associated with accounts 56, the attempted update may fail for one or more accounts 56. In such an instance, an error message such as that shown in FIG. 5 may be displayed, informing the user of the failed update and asking the user if the user would like to view the status of any account(s) 56 for which the update failed. If the user selects “No,” then the display would return to the summary page of FIG. 4 (although one or more of the status flags 60 might change to indicate the status of the failed update) or to another page of the financial software application 44. If the user selects “Yes,” then an account manager screen such as that shown in FIG. 6 might be displayed.

In the account manager display of FIG. 6, various account status flags 60 (of different colors, shapes, or both) may be associated with the user's various accounts 56. In some embodiments, an account 56 that encountered no scripting errors during an attempted update may have no status flag 60 associated with it, as with the first account depicted in FIG. 6. In other embodiments, such an account may have a status flag 60 associated with it signaling an OK status. These status flags 60 are a first improvement in communication to the user of the status of script error management efforts. Essentially, the status flags 60 may be displayed in any and all screens and/or displays seen by the user, and may be dynamically and/or continuously updated to show progress in the service provider's efforts to repair broken scripts. Therefore, a user using financial software applications 44 in accordance with embodiments of the present invention would not need to access the account manager display of FIG. 6 to obtain an overview of the status of the broken scripts and of repairs, but would be able to visually obtain at least a summary of the status from any number of pages or screens within the financial software application 44.

When a user desires more than the status summary provided by the status flags 60, reference may be made in some embodiments to the account manager screen such as in FIG. 6. This screen may provide additional information not readily conveyed by the status flags 60. For example, the accounts 56 shown in FIG. 6 illustrate four different statuses of accounts 56 and provide additional information about those statuses. For example, the first account 56 (“My Checking” at “America First Credit Union”) is displayed as having a status of a successful update, and has no status flag 60. The account manager screen may provide additional information by showing the date and time the successful update occurred. As another example, the last three accounts (all three accounts at “Bank of America”) have a similar or identical status and therefore display the same status flag 60. By way of example, the status flag 60 associated with these accounts may be a red status flag 60 (other colors or shapes may be used instead) to signal that the attempted update failed and further signaling that a ticket requesting that the error be fixed has not yet been submitted to the service provider.

This status is further illustrated and explained to the user by providing a submit ticket link 64 (or submit ticket button) within a message field 66. The submit ticket link 64 is another improvement provided by embodiments of the present invention. Currently, when a user discovers an update error due to a broken script, the user is merely provided an error code and is required to contact the service provider directly by telephone or e-mail to report the problem and provide the error code to the service provider, who manually enters a ticket, conducts customer service efforts, requests that the script be repaired, and notifies the user by return call or e-mail when the script is repaired. The submit ticket link 64 improves on current methods in that a user may now submit a ticket merely by selecting the submit ticket link 64.

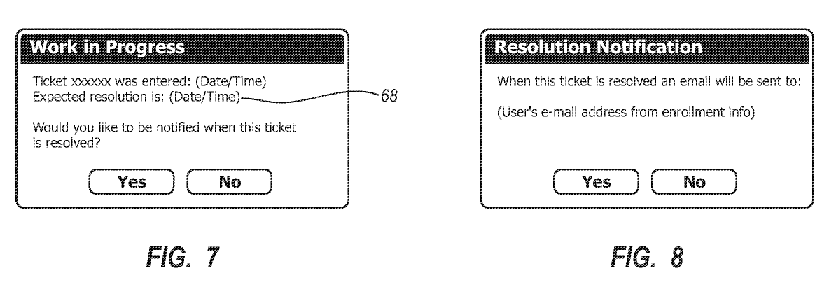

If a users selects the submit ticket link 64 for an account 56 for which the submit ticket link 64 is available, the user may be prompted for confirmation that the user wishes to submit a ticket for the error. Alternatively, a ticket may be submitted immediately to the service provider via the network 38, and the user may be provided with a pop-up display such as that shown in FIG. 7. This display may notify the user that the ticket has been submitted and immediately provides the user with feedback as to when the script error is expected to be resolved, providing an expected resolution date and time message 68. Additionally, the user may be prompted to select whether the user would like to receive an e-mail notification that the error has been corrected, as is displayed in FIG. 7. If the user selects “No,” then the display returns to the account manager or some other display in the financial software application 44, except that the status flag 60 and status message in the message field 66 will be updated to reflect the submission of the ticket and the expected resolution date/time message 68.

If, however, the user selects “Yes” to be notified by e-mail, a display such as that in FIG. 8 may be displayed. The message would notify the user that an e-mail will be sent and may further indicate to which e-mail address the confirmation e-mail will be sent. The display could then return to the account manager page or other display, with the requisite status flag 60 and message field 66 updates as described above. The expected resolution date and time message 68 displayed to the user as in FIG. 7 and in the message field 66 of the account manager screen is another improvement over currently available methods. Currently, service providers are often unable to inform their customers at the time of ticket submission or even at any time until shortly before or at the time a script error is resolved when the script error is expected to be resolved. How this improvement may be provided is described further below with the discussion of improvements to the service-provider side in conjunction with embodiments of the present invention. The expected resolution date and time message 68 greatly improves customer expectations and understanding of when broken scripts will be repaired, and helps prevent additional customer complaints and service requests that tend to require service provider customer service manpower and therefore reduce the efficiency of the service provider.

While notification by e-mail has been specifically described above, it will be recognized that other forms of automatic notification may be used. By way of example and not limitation, other forms of automatic notification may include automatic notification by text message, automatic notification by pop-up window or sound alert within the financial software application 44, and automatic notification by automated telephone communication. In some embodiments, the user may be provided with an opportunity to select one or more of the above-described or similar methods for automatic notification, either during set-up of the financial software application 44, or at the time of requesting notification of correction of the error.

Returning to FIG. 6, a second status flag 60 and status message are displayed for the second displayed account (“My Savings” at “America First Credit Union”). By way of example, the status flag 60 may be blue instead of red (although any selected color, symbol, or shape may be used to represent the status represented by a blue status flag 60 in FIG. 6). As may be appreciated by reference to FIG. 6, this status flag 60 reflects script errors having work in progress for which a ticket has already been submitted. For accounts 56 having this status, a work in progress link 70 (or work in progress button) may be provided, and a ticket number may also be provided. If the user selects the work in progress link 70, a window similar or identical to the window shown in FIG. 7 may be displayed. This may give the user additional information indicating when a ticket request was submitted, and may further give the user an additional opportunity to select whether to be notified by e-mail when the error has been resolved. This may be advantageous in the case where a user initially selects not to be notified by e-mail but later decides that an e-mail notification is desired.

However, in some instances, the work in progress link 70 may provide the user with additional information beyond the information that may have previously been known by the user. This additional information is related to another improvement provided by embodiments of the present invention. Many script errors are the result of changes in a financial institution's website. In many instances, the changes in an institution's website will affect a number of users simultaneously: a change in the location of the login information, a change in the required information to login, or other changes by the financial institution will prevent the manual or automatic login by the aggregator or other service provider to obtain account information for any number of users on the date the change takes effect. Currently, each user encountering the error has no way of knowing if a ticket has previously been submitted for the error, and customer service centers may be inundated with calls reporting the same error, wasting significant and valuable resources simply providing repetitive customer service support for what amounts to a single scripting error.

In embodiments of the invention, this disadvantage is removed because once one user submits a ticket related to the error, the accounts and updates of all users whose automatic or manual attempted updates encountered the same error are updated to reflect the work in progress status shown in FIG. 6. Therefore, a second user who opens the financial software application 44 and receives an automatic update or request a manual update might still receive a message such as that shown in FIG. 5 or might see a status flag 60 as shown in FIGS. 4 and 6. However, the status flag 60 and associated message would already be updated to show work in progress. Such a user, upon clicking the work in progress link 70 would then be able to learn when the original ticket was submitted by another user, and could also elect to be notified (such as by e-mail) when the error has been resolved. This can greatly reduce customer frustration by allowing customers to see progress being taken in their script errors before they have even become aware of the error and before they have been forced to report such an error.

Of course, it is possible that multiple users might receive their updates and nearly-simultaneously discover that a ticket needs to be submitted to have an error fixed. Therefore, multiple users may select the submit ticket link 64 before the status flags 60 and status messages displayed in the message fields 66 are updated by the service provider. This does not present a problem, as the service provider's computer may but need not generate multiple tickets for the same problem. If multiple tickets are generated for the same problem, the service provider may automatically consolidate or link the multiple tickets. Alternatively, the first ticket request to arrive may be assigned a ticket number, and later-arriving ticket requests may simply be referred to the first-generated ticket. This is advantageous in that the experience of the user is identical regardless of the approach used by the service provider, and that experience is uniformly better than what is currently available.

The third account 56 shown in FIG. 6 (“My Visa” at “America First Credit Union”) illustrates yet another status flag 60 and status of the account 56. By way of example, the status flag 60 may be a yellow status flag 60 instead of a blue or red status flag 60 (although any color, shape, or symbol may be used to represent the alternate status). In the illustrated example, this status shows the user that user action is required to complete the script repair process, and a user action required link 72 (or user action required button) may be provided to allow the user to take the necessary action.

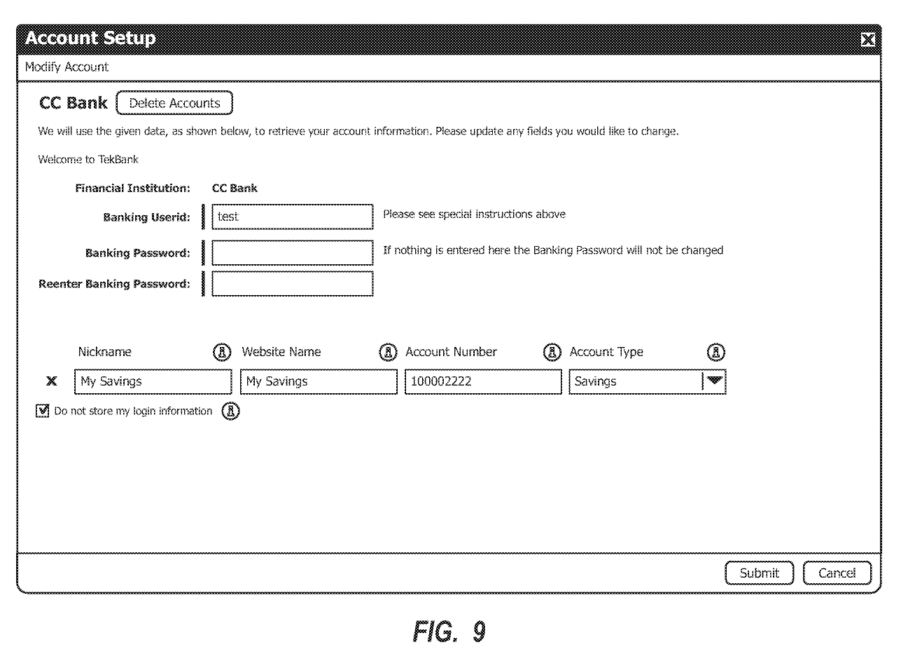

Even when a service provider's script engineers 54 have repaired scripts to function according to financial institutions' changed web pages, additional user action will sometimes be required. This may be the case, for example, when the financial institution previously permitted login to the site using a simple user name and password, and updates its site to include a challenge question. When the script has been fixed and such user action is required, a screen such as that shown in FIG. 9 may be displayed when the user selects the user action required link 72.

Depending on the nature of the financial institution's website changes, the screen similar to that of FIG. 9 may display any number of fields, including User ID fields, Password fields, and fields in which a user may be prompted to enter challenge questions and the user-selected answers as they appear on the financial institution's website. Those of skill in the art will readily recognize the various fields and prompts that may be displayed upon showing an account setup page to receive user input for fixing script changes necessitated by financial institution webpage changes. In some instances, the user will be required to take certain actions on the financial institution's website in order to obtain the necessary information. In such cases, the financial software application 44 may provide prompts and/or instructions on how to obtain the necessary information. Once the additional user information has been obtained or user action taken, an attempt to update the affected accounts may be initiated automatically or may be initiated by the user by selecting the refresh button 62 (or other refresh button or link), and an evaluation of the success of the update attempt may be made by the financial software application 44 in order to appropriately update the status flags 60 and status messages associated with the account(s) 56.

Therefore, for all the above reasons, the embodiments of the invention provide a much-enhanced script-error experience for users of the financial software applications 44. While the above-discussed improvements provide improvements to both the client/consumer side of the script corrections process and the service-provider side of the process, the above discussion has been primarily focused on the improvements as viewed from the client/consumer side of the process. The following discussion focuses now on improvements on the service-provider side of the script repair process.

The first group of improvements provided by embodiments of the current invention are those improvements seen by limiting the number of interactions between customer support staff and users of the financial software application 44. As one of skill in the art will readily appreciate, reducing such interactions may provide significant improvements to a service provider as the service provider need not expend as many resources in providing customer service interactions to the service provider's clients. The number of customer service interactions is first reduced by providing users with the ability to self-submit ticket requests using the submit ticket link 64. This practice omits the need to have a customer service agent receive and respond to a user's telephone call.

In some instances, however, it may still be desirable to have customer service agents available to respond to customer's calls regarding script errors. For example, a service provider in the process of converting between currently-available methods to methods and systems in accordance with the embodiments of the invention may have a large number of customers initially unaware of the new self-submit ticketing process. Or a customer may call in for some other reason and submit a ticket request. In such cases, a customer service representative may use a software application or tool such as the administrative tool or application 48 to access ticket information data and to enter a new ticket, if necessary. For example, the representative or support agent 52 may view the accounts 56 for the calling user and may also have access to see any previously-existing tickets that apply to the user's account(s) 56. If there is not an existing ticket for the account 56, the support agent 52 can select the account 56 and script error and create a new ticket. However, the ticket may not be created just for that particular user's account(s) 56, but may simultaneously be attached to all other accounts 56 of other users similarly affected by the broken script (typically those accounts 56 for the same financial institution having the same error code). Then, all other users of the financial software application 44 will automatically receive status flags 60 and status messages as discussed above, greatly reducing the likelihood and/or number of customer calls to the service center.

Thus, embodiments of the invention are intended to work so as to limit touch points between customer services representatives and users to a single instance the first time a user submits a ticket. As discussed above, in many instances, this single touch point will be an electronically-submitted ticket request that will not require significant customer support staff time and interaction, as the currently-used direct telephone call error reporting methods require. Person-on-person customer interaction is further reduced by providing as much information directly to the client as possible, such as by providing the various account status flags 60 and repair status messages from within the financial software application 44.

In some embodiments of the invention, it is desirable to proactively detect and repair script failures before receiving a ticket request from a user. Proactive repair of script failures ensures higher customer satisfaction with the service providers/aggregators, as the fewer failures to update a customer experiences, the higher the likelihood the customer will be satisfied with his or her experience with the service provider. As discussed above, many aggregators perform automatic updating of customer accounts on a fixed schedule, often during less active times of Internet/network traffic. The aggregators may then store the updates on proprietary servers 42 and provide the updates automatically to users upon users' login to or access of the financial software applications 44.

It is commonly possible for aggregators to detect failures to update during this automatic updating process and to obtain an idea of the number of customers affected by a particular script failure. While some script failures will still only be discovered by individual users attempting manual updates, a large number of script problems may be discovered during the automatic updating process. Therefore, improved methods are needed to balance responsiveness between repairing script errors automatically detected and script errors that have been noticed and reported by users. Embodiments of the invention provide for such an improved balance.

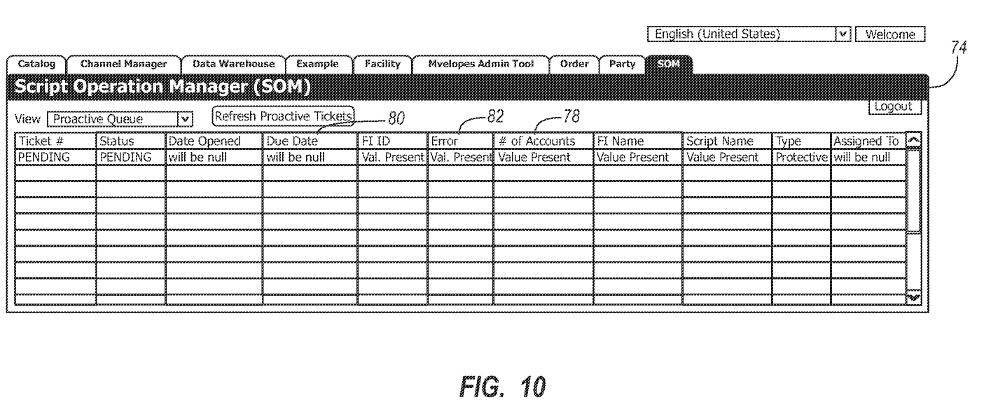

Embodiments of the invention provide this improved balance by queuing discovered script errors in multiple queues. For example, some embodiments of the invention provide two queues of discovered broken scripts awaiting repair: a proactive queue 74 and a reactive queue 76. An example of how a proactive queue 74 might be presented to an individual on the service-provider side is presented in FIG. 10. The individual viewing the proactive queue 74 may be any individual associated with the service provider or aggregator, including a support agent 52 or other customer service representative, a queue manager, a script engineer 54, etc. If an aggregator's automatic systems are scraping the various user accounts at the various institutions perfectly (i.e., no script errors or broken scripts are detected and updates are successfully achieved), the proactive queue 74 remains empty.

If, however, the scraping does not occur perfectly, and at least some updates fail, a ticket relating to that error may be automatically generated and placed on the proactive queue 74. In doing so, some embodiments of the invention will determine the number of accounts affected by each ticketed script error. The scripts errors having tickets on the proactive queue 74 are addressed by script engineers 54 in some order, and as the scripts are repaired, new attempts at updates may be initiated. In this way, many users of the financial software application 44 may never know that a script error has occurred and been repaired. The order in which tickets are placed and ordered on the proactive queue 74 may be selected by any number of methods as estimated to best improve the satisfaction of the aggregator's/service provider's customers. For example, the script repair order on the proactive queue 74 may be ordered by the number of affected accounts 78. Alternatively, the script repair order on the proactive queue 74 may be ordered according to a first-in-first-out order: the first broken script discovered will be repaired first, and so on.

Another method of ordering repairs on the proactive queue 74 may be to provide some evaluation of the difficulty of repair and repair those errors that are easier to fix first in order to minimize the number of accounts 56 affected by broken scripts before users discover the update failures. Still other methods may be used, including combinations of the above. For example, a customer service provider may guarantee that all scripts will be proactively repaired within a certain fixed time, such as twenty-four hours, and broken scripts affecting fewer users may be ordered so as to be repaired later on the proactive queue 74 until either those errors affecting more customers are fixed or the twenty-four-hour time period for certain script errors approaches, at which point the errors affecting fewer customers would be given higher priority. Those of skill in the art can readily recognize the many other manners that might be used to order tickets on the proactive queue to improve a service provider's/aggregator's customer image for repairing script errors.

In certain embodiments of the invention, regardless of whether tickets are already located on the proactive queue 74, customers may be provided with a submit ticket link 64 so as to permit the customers to request expedited handling of their broken scripts. If a ticket already exists on the proactive queue 74 and a customer submits a ticket request, a new ticket may or may not be generated. In some embodiments, the existing ticket on the proactive queue 74 may be located and moved to the reactive queue 76, and may be associated with any ticket generated by the customer's request. In other embodiments, a new ticket may be generated on the reactive queue 76 and then the reactive queue 76 and/or the proactive queue 74 may be scanned or searched for other accounts/tickets affected by the same script and those accounts/tickets may be swept in to the new ticket on the reactive queue 76 as riders. In some embodiments, once a ticket is placed or has been moved to the reactive queue 76, it receives expedited handling. If no ticket exists on the proactive queue 74 corresponding to the customer's ticket request (e.g. the customer discovered the broken script because the broken script was missed during scraping or because the financial institution's website changed between the last automatic scraping and a manual update initiated by the user, etc.), then a new ticket may be generated and placed on the reactive queue 76.

In some embodiments, when a certain ticket on the proactive queue 74 either has been on that queue for too long a time or when that ticket is selected for repair or is about to be selected for repair, the ticket may be transferred to the reactive queue 76, and/or the submit ticket link 64 in the user's financial software application 44 may be disabled and the status of the error updated to reflect that the script will be repaired shortly. This works in conjunction with the other methods and systems described herein to reduce the number of customer service interactions and user-initiated ticket requests, and also provides improved reporting to customers of when the broken scripts will be repaired.

When tickets are located on the reactive queue 76, they may be treated differently than those tickets on the proactive queue 74, or they may be treated in a similar fashion, but in an expedited manner. For example, a service provider having a commitment to repair all broken scripts having tickets on the proactive queue 74 within twenty-four hours might further commit to repairing all broken scripts having tickets on the reactive queue 76 within four hours. Thus the service provider might commit to repairing broken scripts within four hours of a ticket submission by a customer. Thus, while the various organization algorithms discussed above in relation to the proactive queue 74, such as first-in-first-out, number of affected users, and total time on the queue may be applicable to the reactive queue 76, it is anticipated that some service providers may give more emphasis to such considerations as total time on the queue and first-in-first-out types of ordering.

Additionally, some ordering between tickets on the proactive queue 74 and the reactive queue 76 may be necessary. While any type of such ordering is embraced by the embodiments of the invention, it is anticipated that at least some service providers will give first priority to those repair tickets on the reactive queue 76 over those on the proactive queue 74, as presumably the tickets on the reactive queue 76 have already been noticed by customers of the service provider/aggregator.

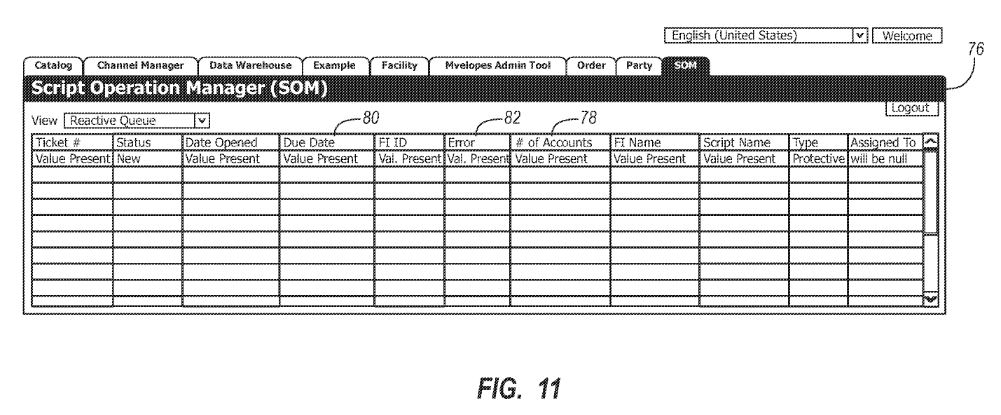

FIG. 11 shows a depiction of one embodiment of a reactive queue 76. The depicted embodiment is similar to the embodiment of the proactive queue 74 depicted in FIG. 10. Both queues 74, 76 may provide important information to script engineers 54, SOM applications 55, and other managers of the service provider's activities. Such information may include due dates and times 80, error identifiers 82, the number of affected accounts 78, a number of ticket generation requests received by customers, etc. Another field that may be included in the queues 74, 76, particularly the proactive queue 74, is the type of error encountered. The errors that may be encountered include user errors (such as providing an incorrect username, password, or challenge question answer), website-related errors (such as connection failures and time-outs), and actual script failures. For user-related errors, a status flag 60 and message may be presented to the user, prompting the user that additional user action is required. For website-related errors, a status flag 60 and message may be presented to the user of the financial software application 60 indicating to the user that the financial institution's website is experiencing problems and providing the user an opportunity to attempt a manual update. Finally, for actual script errors, action may be taken by the service provider and status flags 60 and additional information provided to the users as described above.

Because of the great improvements in efficiency that are anticipated with the embodiments of the invention, it is anticipated that service providers and aggregators will be better able to detect and fix additional problems, such as nested failures, than is currently possible. For example, using current methods, most service providers are unable to individually test every account affected by a script error to see if the repaired script works for all users. Instead, script engineers 54 now typically only test a certain number of accounts, such as a certain percentage or number at the top of the scrip ticket list. Using embodiments of the invention, it is anticipated that the increased efficiency provided will allow the script engineers to perform full testing of all affected accounts before sending out messages that the error has been repaired. This will permit the detection of other errors, such as nested failures, and the customer image of the service provider will therefore be improved as the number of failures discovered by customers decreases.

Another improvement over current methods of script repair management is provided by the capability for improved communication within the service-provider side, specifically communication with and between customer service representatives/support agents 52, script engineers 54, and other process managers. This may be particularly important in cases where one or more of the parties involved in script repair is a third party. For example, some service providers and aggregators may contract with a third party to provide script engineer support for repairing the detected script errors. The automatic ticketing and queuing described herein may improve communications between such parties and may improve the efficiency with which script errors may be repaired. For example, in accordance with the various queuing and ordering methods described above, various tickets may be properly ordered for repair and assigned to available script engineers 54 in an orderly and timely basis.

In some embodiments, script engineers 54 may be provided with various screens and views similar to those shown in FIGS. 10 and 11. The script engineers 54 may be provided with the proactive queue 74 and reactive queue 76 and may have similar views provided showing queues of those scripts/error tickets assigned to the particular script engineers 54. Script engineers 54 may be provided with the ability to edit certain listings, such as by changing script ticket assignments to those script engineers 54 with the best ability to handle certain problems, and by entering updates as to the status of script repairs. The updated status may then be transmitted as described above within the service-provider side as well as directly to the user of the financial software application 44. These views may be available to the script engineers 54 in the SOM application 55 or in some other application. While not specifically set forth herein, those of skill in the art will readily appreciate the many ways in which management of the various tickets on the various queues may be handled and still fall within the spirit of the embodiments of the invention.

Additional advantages of the embodiments of the invention may be readily appreciated from the above description. By way of example, the improved queuing and tracking of script tickets disclosed herein may permit improved evaluation of performance of script engineers 54, of the frequency of script changes at certain institutions, of the number of script errors experienced by certain users of the financial software applications 44, the performance of individuals and teams, and the kinds and frequencies of the various types and classes of errors.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for improving script operations management comprising:
providing a financial software application to a first user;
receiving a selection of a link to request repair of a damaged script from the first user through the financial software application;
automatically generating a script repair ticket corresponding to the selection of the link to request repair of the damaged script;
providing an estimated repair time to the first user of the financial software application;
repairing the damaged script; and
notifying the first user that the script has been repaired.

2. A method as recited in claim 1, further comprising:
linking accounts of additional users of the financial software that have an error associated with the damaged script to the script repair ticket;
providing the estimated repair time to any of the additional users who access the financial software application before the damaged script is repaired.

3. A method as recited in claim 2, further comprising:
receiving a request from a subset of the additional users to be notified when the script has been repaired; and
notifying the subset of the additional users that the script has been repaired.

4. A method as recited in claim 1, wherein notifying the first user that the script has been repaired comprises changing the status of one of a notification flag and a notification message in the financial software application.

5. A method as recited in claim 1, wherein notifying the first user that the script has been repaired comprises an action selected from the group of:
sending an e-mail to the first user;
sending a text message to the first user;
contacting the first user by telephone; and
providing an alert to the first user within the financial software application.

6. A method as recited in claim 1, wherein repairing the damaged script further comprises:
determining that additional action by the first user is required to restore full functionality to the damaged script;
reporting to the first user that the additional action is required; and
completing repair of the damaged script for the first user after the first user performs the additional action.

7. A method as recited in claim 6, wherein repairing the damaged script further comprises:
determining that additional action by the additional users is required to restore full functionality to the damaged script;
reporting to the additional users that the additional action is required; and
completing repair of the damaged script for the additional users after the additional users perform the additional action.

8. A method as recited in claim 1, further comprising providing the first user with an updated estimated repair time through the financial software application.

9. A method as recited in claim 1, further comprising updating a status identifier of the financial software application and for an account of the first user associated with the damaged script to a status indicating that repairs are in progress when the script repair ticket is generated.

10. A method as recited in claim 1, further comprising merging the script repair ticket with additional script repair tickets received from additional users.

11. A method for improving script operations management comprising:
detecting a script failure at a financial institution web page that prevents an automatic aggregation of a first customer's account information by a financial service provider;
automatically generating a request to repair the script failure;
determining whether aggregation of additional customers' account information is also affected by the script failure and if the script failure affects aggregation of the additional customers' account information, joining the affected additional customers' accounts to the request to repair the script failure;
prioritizing the request to repair the script failure with any other requests on a proactive script repair queue; and
repairing any scripts affected by the script failure.

12. A method as recited in claim 11, further comprising removing the request to repair the script failure from the proactive queue.

13. A method as recited in claim 11, further comprising providing the first customer with an estimate of the time to repair the script failure.

14. A method as recited in claim 13, further comprising providing the additional customers whose account information is also affected by the script failure with the estimate of the time to repair the script failure.

15. A method as recited in claim 11, further comprising notifying the first customer that the script failure has been repaired.

16. A method as recited in claim 11, wherein prioritizing the request to repair the script failure comprises prioritization of requests based on at least one of:
a number of accounts affected by the script failure;
an estimated difficulty of repair of the script failure;
a first-in-first-out prioritization scheme;
a total length of time since the script failure was detected; and
a maximum-time-to-repair commitment.

17. The method of claim 11, further comprising:
receiving a request from a second customer to repair the script failure;
generating and prioritizing a reactive request to repair the script failure on a reactive queue; and
associating the automatically-generated request to repair the script failure on the reactive queue with the reactive request to repair the script failure on the reactive queue.

18. A computer-readable medium storing a computer program product for implementing a method for improving script operations management, the computer program product comprising computer program code means for:
providing a financial software application to a first user through a global computer network;
receiving a selection of a link to request repair of a damaged script from the first user through the financial software application and the global computer network;
automatically generating a script repair ticket corresponding to the selection of the link to request repair of the damaged script;
providing an estimated repair time to the first user of the financial software application;
repairing the damaged script; and
notifying the first user that the script has been repaired.

19. A computer-readable medium as recited in claim 18, wherein the computer program product further comprises computer program code means for:
linking accounts of additional users of the financial software that have an error associated with the damaged script to the script repair ticket;
providing the estimated repair time to any of the additional users who access the financial software application before the damaged script is repaired.

20. A computer-readable medium as recited in claim 19, wherein the computer program product further comprises computer program code means for:
receiving a request from a subset of the additional users to be notified when the script has been repaired; and
notifying the subset of the additional users that the script has been repaired.
